(19) United States
(12) Patent Application Publication
(10) Pub. No.: US 2015/0107313 A1
(43) Pub. Date: Apr. 23, 2015

(54) UNIVERSAL LOCK

(71) Applicants: Kai Gröne, Witten (DE); Marc-André Schneider, Ennepetal (DE)

(72) Inventors: Kai Gröne, Witten (DE); Marc-André Schneider, Ennepetal (DE)

(73) Assignee: DORMA Deutschland GmbH

(21) Appl. No.: 14/516,173

(22) Filed: Oct. 16, 2014

(30) Foreign Application Priority Data
Oct. 17, 2013 (DE) 10 2013 111 467.9

(51) Int. Cl. E05C 1/00; E05B 15/00

(52) U.S. Cl. CPC E05C 1/00; E05B 15/00
USPC 70/57; 292/137; 292/163; 292/143

(57) ABSTRACT

A lock for a sliding panel for receiving different lock mechanisms includes: a housing configured to receive a lock mechanism; and a locking element configured to lock the lock, the locking element being movable between a locked position in which the locking element projects at least partially from the housing and an unlocked position in which the locking element dips at least partially into the housing. The housing is configured such that at least one actuating element is exchangeably arrangeable in and/or at the housing so that the at least one actuating element is operatively connectable with the locking element to actuate the locking element.

### BACKGROUND OF THE INVENTION

1. Field of the Invention

The invention is directed to a lock, particularly a universal lock, for a sliding panel for receiving different lock mechanisms, with a housing for receiving a lock mechanism and with a locking element for locking the lock, wherein the locking element is movable between a locked position, in which the locking element projects at least partially from the housing, and an unlocked position, in which the locking element dips at least partially into the housing.

2. Description of the Related Art

Various types of locks used in sliding panels are known. These conventional locks differ in the way that they function, in their mode of construction and design and require different component parts. In these various types of locks it has turned out to be disadvantageous that they necessitate a special, varying fashioning of the sliding panels in which they are to be used.

### SUMMARY OF THE INVENTION

It is an object of the present invention to overcome the above-mentioned disadvantage and, in particular, to provide a lock which can be used uniformly in different types of locking mechanisms and which is exchangeable. Further, the lock according to the invention is constructed in a simple manner and is robust against damage during locking movements.

This object may be met by a lock according by a system as set forth below.

In one aspect of the invention, the housing of the lock is configured such that at least one actuating element can be exchangeably arranged in and/or at the housing so that the actuating element can be brought into operative connection, particularly mechanical operative connection, with the locking element directly or via a lock mechanism in order to actuate the locking element. Advantageously, the invention may be a universal lock that combines in one lock all previous lock mechanisms that can be used in horizontal sliding panels. The lock according to an aspect of the invention can advantageously be used with a front locking device, an end locking device and a locking cylinder as actuating element. According to an aspect of the invention, a building block principle is realized, in which the lock housing can always be constructed identically, and can be used in the sliding panels of various sliding panel systems. The standardized housing can advantageously be constructed such that the housing can receive different lock mechanisms, which can be actuated with different actuating elements but can be arranged in a standardized recess in a sliding panel. This allows different variants of sliding panels and sliding panel systems to be realized with one and the same lock. Moreover, all of these variants of the lock mechanisms are interchangeable; the lock according to the disclosed embodiments of the invention is constructed in a standardized manner and can also be installed and used retroactively in all variants thereof. Expenditure for production of the lock can be reduced in this way because one and the same model can be produced in a standardized manner for all sliding panel systems. Further, the lock according to the embodiments of the invention is constructed in a simple manner, is easy to assemble and is not susceptible to possible damage due to locking movements.

The housing according to an aspect of the invention can advantageously be configured such that two and/or three different actuating elements can be exchangeably arranged in and/or at the housing, and each of the actuating elements can be brought into operative connection, particularly a mechanical operative connection, with the respective lock mechanism and/or with the corresponding or standardized locking element in order to actuate the locking element. In this regard, it is conceivable that two, three or even more different models or types of lock mechanism that can be actuated by different actuating elements can be used in one and the same lock. In an advantageous manner, this allows uniform machining of the lock housing and fewer variants of the locking mechanisms needed for different sliding panel systems.

According to an aspect of the invention, the actuating element can be brought into operative connection with the locking element via the lock mechanism. Many actuating elements can be arranged at the housing of the lock or at the end or front of the sliding panel, respectively, such that they cannot be brought directly into operative connection with the locking element. Accordingly, different actuating elements require different lock mechanisms in order to actuate the locking element. However, the lock according to the invention which can accept different lock mechanisms advantageously makes it possible to reliably transmit the action of these different actuating elements to the locking element via the respective lock mechanism.

In an advantageous manner, the actuating element can be brought into mechanical operative connection with the locking element. There are many mechanically operating lock mechanisms that are suitable for sliding panels. Therefore, it is advantageous that the actuating element can be brought into mechanical operative connection with the locking element according to the invention. Additionally or alternatively, however, the lock according to the invention can also be outfitted with electronic or electromechanical lock mechanisms. Accordingly, a broad spectrum of lock mechanisms can advantageously be received in the universal lock according to the invention. Therefore, the configuration of the sliding panel systems can be realized in a flexible manner and adapted to existing spaces and conditions.

According to an aspect of the invention, the housing can be configured such that an actuating element in the form of an end locking device and/or in the form of a front locking device and/or in the form of a locking cylinder, particularly a round cylinder and/or profile cylinder, can be exchangeably arranged in and/or at the housing to actuate the locking element.

The lock mechanism can advantageously have a blocking element, particularly in the form of a ball detent, in order to fix the locking element in the unlocked position. Therefore, the locking element will not be in the way and can also not be damaged when the panel is actuated and moved. Other configurations of blocking element, such as a longitudinally displaceable bolt or a swivelable latch that can be arranged inside or outside of the housing, are likewise conceivable according to the invention.

Further, the lock mechanism can have an energy accumulator, particularly in the form of a compression spring, in order to load the locking element in the locked position. In this way it can be ensured that the locking element is reliably held in the locked position and the lock can be reliably protected against tampering by unauthorized persons.

Further, according to the invention, the lock mechanism can have a connection element, particularly in the form of a lever, in order to produce the operative connection between the actuating element and the locking element. In so doing, it is advantageous that the force during actuation of the actuating element can be optimally transmitted to the connection element and that the existing space in the housing can be utilized to the fullest for producing the operative connection between the actuating element and the locking element.

Further, it is conceivable that the lock mechanism has a transmission, particularly in the form of a screw drive, in order to provide the operative connection between the actuating element and the locking element. Therefore, even more lock mechanisms and actuating elements can advantageously be realized at the lock according to the invention. In this regard, it is conceivable that the lock can be provided with a locking cylinder as actuating element, and a locking cylinder in the form of a round cylinder or profile cylinder can be used with appropriate choice of the transmission.

In an advantageous manner, the locking element can be guided linearly, particularly so as to be longitudinally displaceable, in a guide of the housing between the locked position and the unlocked position. In this way the movement of the locking element can be stabilized and a reliable locking of the lock can be ensured. Further, guiding the locking element in this way provides a robust lock that is not susceptible to damage due to locking movement of the locking element or movement of the sliding panel. In this respect, the locking element can move out of an aperture in the housing and can lock into a corresponding aperture in the base or in a guide rail of the sliding panel. Further, the locking element can advantageously be used as a pivot of the sliding panel so as to expand the possible uses of the sliding panel and provide a broader spectrum of sliding panel systems.

It is further conceivable that the locking element is mounted in the housing so as to be swivelable between the locked position and the unlocked position. There are known lock mechanisms which are locked by swivelable movement of the locking element, wherein the locking element can move into a corresponding aperture of a counter-panel. When the locking element is configured in this way and as a result of the flexibility of the lock according to the invention, swivelable lock mechanisms of this kind can also be realized for a sliding panel.

The locking element can advantageously be constructed in the form of a locking bolt, a locking pin, a latch, a swivel latch or the like. A desirable or required lock system can be achieved in this way, and the lock according to the invention can be configured to correspondingly receive.

An aspect of the invention is based on the idea that the lock can be suitable for use with an actuating element in the form of an end locking device, a front locking device or a locking cylinder, particularly a round cylinder and/or profile cylinder. This advantageously provides a universal lock that combines, in only one lock, all possible lock mechanisms that can be used in horizontal sliding panels. The inventive lock thus makes it possible to realize the building block principle for sliding panels and sliding panel systems, wherein the lock mechanisms can be arranged interchangeably in the lock housing and can also be retrofitted or substituted subsequently. Therefore, expenditure for the production of locks as well as sliding panel systems can be minimized because one and the same lock can be suitable in a flexible manner for all sliding panel systems. Further, the inventive lock can be assembled in a simple manner and is not susceptible to possible damage during operation of the sliding panel.

Further, an object according to the invention is met by a system which can have a lock, particularly such as that described above, with a housing for receiving a lock mechanism and a locking element for locking the lock. In this regard, the locking element can be movable between a locked position in which the locking element projects at least partially from the housing and an unlocked position in which the locking element dips at least partially into the housing. The system according to an aspect of the invention can be provided with at least one actuating element for actuating the locking element, and the lock can be configured in such a way that the actuating element can be exchangeably arranged at the housing so that the actuating element can be brought into operative connection with the locking element in order to actuate the locking element. Consequently, the invention advantageously allows a broad spectrum of lock mechanisms to be received in only one lock, or universal lock, by the system according to the invention. Accordingly, the configuration of the sliding panel systems can advantageously be realized in a flexible manner and adapted individually to existing spaces and requirements.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Further steps improving the invention are set forth in detail in the following together with the description of a preferred embodiment example of the invention referring to the drawings. In the drawings:

FIG. 1 is a schematic diagram of a lock according to the invention with an end locking device as actuating element;

FIG. 2 is a schematic diagram of a lock according to the invention with a front locking device as actuating element; and

FIG. 3 is a schematic diagram of a lock according to the invention with a locking cylinder as actuating element.

### DETAILED DESCRIPTION OF THE PRESENTLY PREFERRED EMBODIMENTS

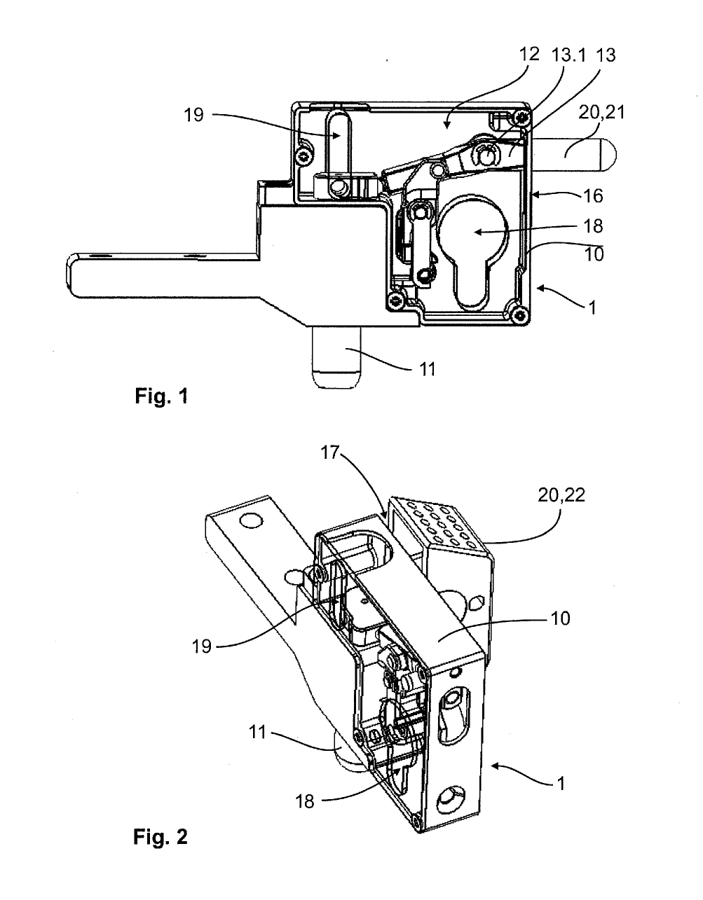

FIGS. 1 to 3 show a lock 1 according to the invention which is advantageously constructed as a universal lock and is suitable for a sliding panel for receiving different lock mechanisms 12. The lock 1 comprises a housing 10 for receiving a lock mechanism 12 and a locking element 11 for locking the lock 1. The locking element 11 is movable between a locked position in which the locking element 11 projects from the housing 10 and an unlocked position in which the locking element 11 dips into the housing 10. The locked position of the locking element 11 is shown in FIGS. 1 to 3.

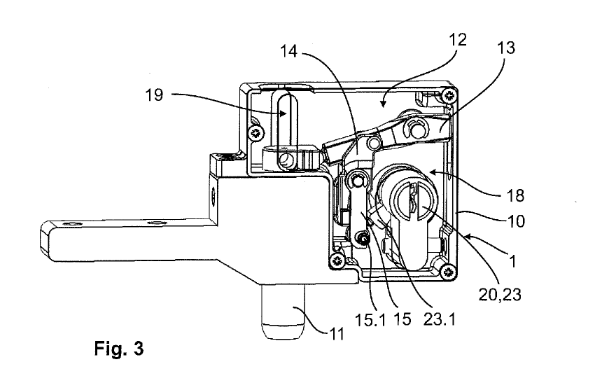

According to disclosed embodiments of the invention, the housing 10 of the lock 1 is shaped such that different actuating elements 20 can be exchangeably arranged in and/or at the housing 10 and the actuating elements 20 can be brought into mechanical operative connection with the locking element 11 directly or via the lock mechanism 12 in order to move the locking element 11 between the locked position and the unlocked position. The actuating element 20 is shown in FIG. 1 in the form of an end locking device 21, in FIG. 2 in the form of a front locking device 22, and in FIG. 3 in the form of a locking cylinder 23. Accordingly, it will be apparent that the invention is a universal lock 1, which can receive different lock mechanisms 12 to produce the operative connection between the respective actuating element 21, 22, 23 and the locking element 11. In FIG. 1, the lock mechanism 12 is used in the form of a lever 13 in the housing 10 according to an embodiment of the invention and realizes the operative connection between the end locking device 21 and the locking element 11. FIG. 2 shows that the front locking device 22 can be arranged at the housing 10 according to an embodiment of the invention in such a way that the action of the front locking device 22 is transmitted directly to the locking element 11. In FIG. 3, the lock mechanism 12 is used in the housing 10 according to an aspect of invention in the form of a transmission 13, 14, 15 produces the operative connection between the locking cylinder 23 and the locking element 11.

A noteworthy aspect of the invention is that the lock 1 is realized as a building block. The housing 10 is always identically constructed and can be used with lock mechanisms 12 of widely different locking systems. The standardized housing 10 is constructed such that different lock mechanisms 12 can be received therein, these different lock mechanisms 12 can be actuated by different actuating elements 20 as shown in FIGS. 1 to 3. The shape and size of the housing 10 according to the invention correspond to a standardized dimension such that the same lock 1 can be used in a standardized recess of any sliding panel. Accordingly, the sliding panel systems can also be composed in a flexible manner as a kind of building block so as to correspond to various spatial conditions. Further, all of these variants of the sliding panel systems and of individual sliding panels and individual locks are interchangeable. The lock 1 according to the invention makes possible a standardized production of locks and sliding panels, and production costs and assembly effort can be considerably reduced compared to conventional systems. The lock 1 according to the invention is constructed in a simple manner and for this reason is not only easy to produce but also easy to assemble. Further, the lock 1 according to the invention is robust against potential damage during assembly or operation of the sliding panel.

As can be seen in FIGS. 1 to 3, the housing 10 according to the invention is configured such that three different actuating elements 21, 22, 23 can be exchangeably arranged at the housing, and each actuating element 21, 22, 23 can be brought into a mechanical operative connection with the respective lock mechanism 12 and/or directly with the locking element 11 in order to actuate the locking element 11.

According to an embodiment the invention, the housing 10 is configured such that an actuating element 20 in the form of an end locking device 21 can be exchangeably arranged at the housing 10, as can be seen in FIG. 1. In so doing, the housing 10 is constructed with an end-side aperture 16 in which the end locking device 21 can be movably received. The end locking device 21 can be attached to a lever 13, which functions as lock mechanism 12 and provides the operative connection to the locking element 11. The connection between the end locking device 21 and the lever 13 can be realized, for example, by a ball joint. The lever 13 may be swivelably arranged at a pin 13.1 in the housing 10, for example. Other arrangements are also possible. The locking element 11 can be lifted into the unlocked position via the lever 13 by pressing the end locking device 21 downward, for example, with the foot or hand, so that the lock 1 is unlocked. A blocking element in the form of a ball detent can be provided according to the invention in order to fix the locking element 11 in the unlocked position. By lifting the end locking device 21, the locking element 11 is pressed downward into the locked position via the lever 13 so that the lock 1 is locked. The locking element 11 projects out of an aperture in the base of the housing 10 and can lock into a corresponding aperture in the base or in the guide rail of the sliding panel. The locking element 11 can be loaded downward in the locked position by a compression spring to secure the lock 1. Accordingly, one sliding panel in the sliding panel systems can be locked and when the next sliding panel is slid in front of it the end locking device 21 can dip into the profile of the latter. The lock 1 can then not be unlocked.

Further, according to an embodiment of the invention, the housing 10 is advantageously configured such that an actuating element 20 in the form of a front locking device 22 can be exchangeably arranged at the housing 10, as can be seen in FIG. 2. To this end, the housing 10 is constructed with a front aperture 17 in which the front locking device 22 can be movably received. The front locking device 22 can be attached directly to the locking element 11. The connection between the front locking device 22 and the locking element 11 can be realized, for example, by a ball joint. By lifting or pressing down on the front locking device 22, the locking element 11 can be lifted into the unlocked position or lowered into the locked position, so that the lock 1 is unlocked or locked. In the unlocked position, the locking element 11 can be secured by a ball detent. In the locked position, the locking element 11 can be loaded downward by a spring which prevents a lifting of the locking element 11 and ensures against tampering. To unlock the lock 1 again, the front locking device 22 can be pulled out somewhat and subsequently lifted as is shown in FIG. 2.

It is further provided, according to another embodiment of the invention, that the housing 10 is configured in such a way that an actuating element 20 in the form of a locking cylinder 23 can be exchangeably arranged at the housing 10, as is shown in FIG. 3. In so doing, the housing 10 is constructed with a front aperture 18 in which the locking cylinder 23 can be received. The locking cylinder 23 can be brought into mechanical operative connection with the locking element 11 via a transmission 13, 14, 15 comprising the lock mechanism 12. To this end, a locking plate 15 is provided that can lock at a threaded pin 15.1 in the housing 10 to implement locking of the lock 1. In the locked position of the locking element 11, the locking plate 15 hooks behind the threaded pin 15.1 and accordingly locks the lock 1. By turning a key in clockwise direction, a nose 23.1 of the locking cylinder 23 pushes the locking plate 15 to the side and as the locking cylinder 23 rotates further an adapter 14 is lifted by the nose 23.1 of the locking cylinder 23. The adapter 14 acts on the lever 13, which lifts the locking element 11 into the unlocked position. In the unlocked position, the locking element 11 can be secured by a ball detent. For locking, the key must be turned in counterclockwise direction. The nose 23.1 then pushes the locking plate 15 to the side and pulls the adapter 14 downward. Accordingly, lever 13 and locking element 11 move downward. In the locked position, the locking element 11 can be loaded downward by an energy accumulator in the form of a spring in order to prevent lifting of the locking element 11 and to protect against tampering. In this regard, it is conceivable that the lock 1 can be used with a locking cylinder 23 in the form of a round cylinder or profile cylinder.

According to the invention and referring to FIGS. 1 to 3, the locking element 11 is guided linearly and longitudinally displaceably in a guide 19 of the housing 10 between the locked position and the unlocked position. In this way the movement of the locking element 11 is stabilized and a reliable locking of the lock 1 is realized. Accordingly, the lock 1 according to the invention is constructed in a simple yet stable manner and is robust against damage due to the locking movement of the locking element or movement of the sliding panel. According to the invention, the locking element 11 can be used as a pivot of the sliding panel when in the locked position. Accordingly, the sliding panel systems can be configured in a user-defined and variable manner.

According to the invention, it is conceivable that other forms of locking element 11 can also be mounted at the housing 10 between the locked position and unlocked position. For example, the locking element 11 can be used in the form of a swivel latch or the like so that an even greater variety of lock mechanisms 12 can be accepted by the lock 1 according to the invention.

The invention is not limited in terms of construction to the preferred embodiment examples mentioned above. On the contrary, there are a number of conceivable variants which make use of the solution set forth also in constructions of a fundamentally different kind. All of the features and/or advantages stemming from the claims, description or drawings and embodiment examples, including constructional details and spatial arrangements, can be important features of the invention both by themselves and in diverse combinations. The materials for the housing 10, locking element 11, actuating element 20 and corresponding lock mechanism 12 can be selected appropriately depending on the type of lock mechanism 12 and/or sliding panel system. The housing 10, locking element 11, actuating element 20 and corresponding lock mechanism 12 can be offered according to the invention individually or in any combination as system.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A lock (1) for a sliding panel for receiving different lock mechanisms, comprising:
a housing (10) configured to receive a lock mechanism (12); and
a locking element (11) configured to lock the lock (1), the locking element (11) being movable between a locked position in which the locking element (11) projects at least partially from the housing (10) and an unlocked position in which the locking element (11) dips at least partially into the housing (10),
wherein the housing (10) is configured such that at least one actuating element (20) is exchangeably arrangeable in and/or at the housing (10) so that the at least one actuating element (20) is operatively connectable with the locking element (11) to actuate the locking element (11).

2. The lock (1) according to claim 1, wherein the housing (10) is configured such that at least two different actuating elements (21, 22, 23) are exchangeably arrangeable at the housing (10), wherein each of the at least two actuating elements (21, 22, 23) is operatively connectable with the locking element (11) to actuate the locking element (11).

3. The lock (1) according to claim 2, wherein the at least two actuating elements (21, 22, 23) are operatively connectable with the locking element (11) via the lock mechanism (12).

4. The lock (1) according to claim 2, wherein the at least two actuating elements (21, 22, 23) are mechanically operatively connectable with the locking element (11).

5. The lock (1) according to claim 1, wherein the housing (10) is configured such that the at least one actuating element (20) is configured as an end locking device (21) and/or a front locking device (22) and/or a round cylinder and/or profile locking cylinder (23), and is exchangeably arrangeable in and/or at the housing (10) to actuate the locking element (11).

6. The lock (1) according to claim 1 wherein the lock mechanism (12) has a blocking element, configured as a ball detent, to fix the locking element (11) in the unlocked position.

7. The lock (1) according to claim 1, wherein the lock mechanism (12) has an energy accumulator, configured as a compression spring, to load the locking element (11) in the locked position.

8. The lock (1) according to claim 1, wherein the lock mechanism (12) has a connection element (13), configured as a lever (13), to produce the operative connection between the actuating element (20) and the locking element (11).

9. The lock (1) according to claim 1, wherein the lock mechanism (12) has a transmission (13, 14, 15), configured as a screw drive (13, 14, 15), to provide the operative connection between the actuating element (20) and the locking element (11).

10. The lock (1) according to claim 1, the housing further comprising a guide (9), wherein the locking element (11) is linearly guidable so as to be longitudinally displaceable in the guide (9) of the housing (10) between the locked position and the unlocked position.

11. The lock (1) according to claim 1, wherein the locking element (11) is mounted in the housing (10) so as to be swivelable between the locked position and the unlocked position.

12. The lock (1) according to claim 1, wherein the locking element (11) is configured as one from among the group consisting of a locking bolt, a locking pin, a latch, and a swivel latch.

13. The lock (1) according to claim 1, wherein the at least one actuating element is an end locking device (21).

14. The lock (1) according to claim 1, wherein the at least one actuating element is a front locking device (22).

15. The lock (1) according to claim 1, wherein the at least one actuating element is a locking cylinder (23), configured as a round cylinder and/or a profile cylinder (23).

16. A system comprising:
a lock (1), the lock (1) having:
a housing (10) configured to receive a lock mechanism (12),
a locking element (11) configured to lock the lock, the lock element (11) being movable between a locked position in which the locking element (11) projects at least partially from the housing (10) and an unlocked position in which the locking element (11) dips at least partially into the housing (10), and
at least one actuating element (20) configured to actuate the locking element (11), wherein the lock (1) is configured such that the at least one actuating element (20) is exchangeably arrangeable at the housing (10) so that the at least one actuating element (20) is operatively connectable with the locking element (11) to actuate the locking element (11).

17. The system according to claim 16, wherein the at least one actuating element (20) is an end locking device (21) and/or a front locking device (22) and/or a locking cylinder (23) configured as a round cylinder and/or a profile cylinder (23).

18. The lock according to claim 1, wherein the lock is a universal lock.

19. The lock according to claim 2, wherein the at least two actuating elements (21, 22, 23) comprise at least three actuating elements.
